(19) United States
(12) Patent Application Publication
(10) Pub. No.: US 2012/0160972 A1
(43) Pub. Date: Jun. 28, 2012

(54) KEYBOARD WITH WRIST SUPPORT

(75) Inventors: KANG WU, Shenzhen City (CN); BO TIAN, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/043,405

(22) Filed: Mar. 8, 2011

(30) Foreign Application Priority Data
Dec. 28, 2010 (CN) 201010609029.1

(51) Int. Cl. A47B 97/00; H01F 7/02

(52) U.S. Cl. 248/118

(57) ABSTRACT

A keyboard includes a support. The support includes two magnetic portions and a plurality of protrusions. The support massages and promotes blood circulation in the hands and wrists of the user.

### BACKGROUND

1. Technical Field

The present disclosure relates to keyboards, and particularly to a keyboard having a wrist support that combats fatigue related symptoms.

2. Description of Related Art

In recent years the growing use of keyboards such as used with personal computers has led to widespread incidence of disorders that afflict large numbers of office personnel. These disorders include aching shoulders and neck and particularly problems with the wrists and hands known as carpal tunnel syndrome. Symptoms of carpal tunnel syndrome may include numbness, tingling, and loss of strength in the hands and wrists. Such symptoms can occur as a result of long hours of repetitive motion such as when typing on a keyboard or manipulating a computer mouse.

In view of these problems, a number of devices have been disclosed which are intended to support the hands and wrists while typing and to absorb vibrations generated by the typing action. However, a typical support for the keyboard is made of stiff, hard plastic, thus it is not particularly comfortable to the user.

Therefore, an improved keyboard with wrist support is desired to overcome the above described shortcomings.

### BRIEF DESCRIPTION OF THE DRAWINGS

FIG. 1 is an isometric, front view of a keyboard in accordance with an exemplary embodiment.

FIG. 2 is a partial cross-section view of the keyboard along a line II-II of FIG. 1.

### DETAILED DESCRIPTION

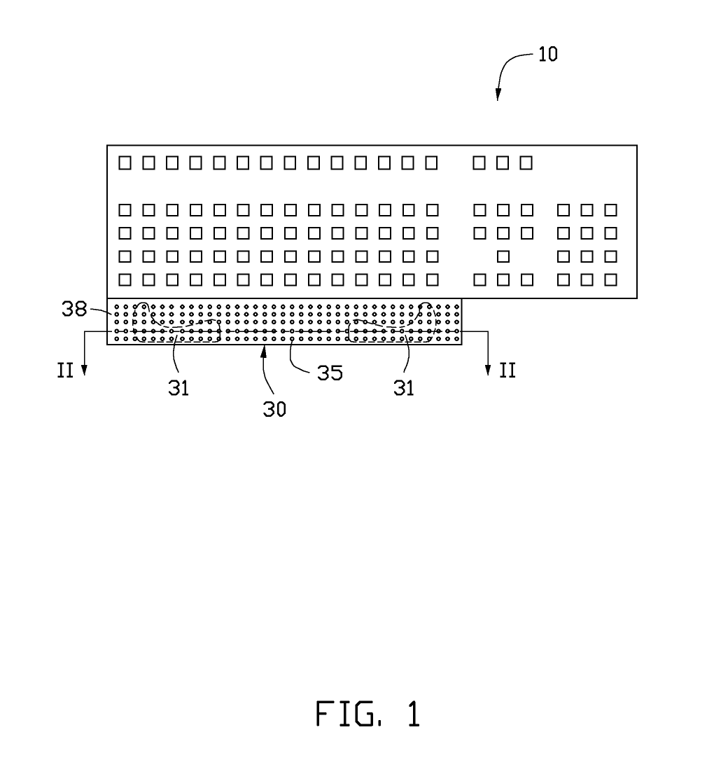

Referring to FIG. 1, a keyboard 10 is illustrated in accordance with an embodiment of the disclosure. The keyboard 10 can be any of known keyboards used with electronic devices such as personal computers.

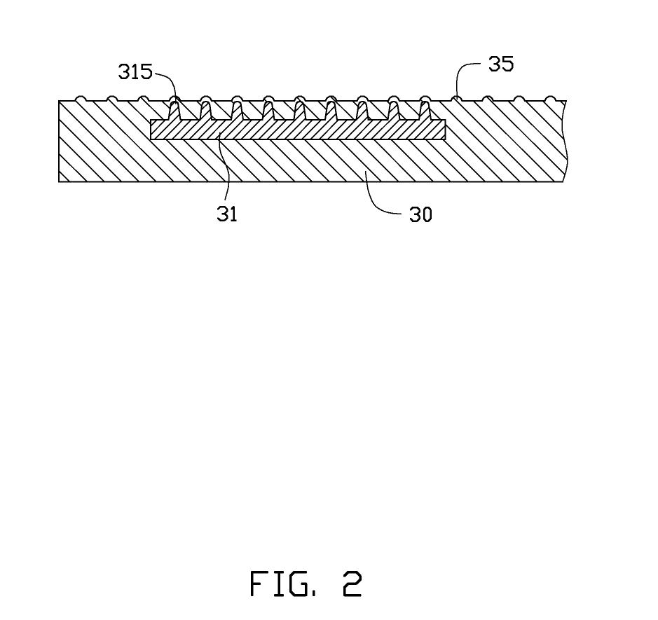

Referring also to FIG. 2, a support 30 is mounted adjacent to keyboard 10 where it can act as a wrist support for users of the keyboard 10. The support 30 includes a main body 38 (see FIG. 1) and two magnetic portions 31 encapsulated in the main body 38. The main body 38 is made of soft, waterproof material, such as silicon rubber, or synthetic resins. A plurality of protrusions 35 protrudes up from the top of the main body. When a user is typing on the keyboard 10 any portion of their wrists and hands that contact the support 30 can benefit in two ways. First, the protrusions 35 effectively provide a massaging effect with the contact area. Second, magnetic fields of the magnetic portions 31 can aid in and promote blood circulation in the hands and wrists.

The magnetic portions 31 are generally L-shaped and spaced from each other, and symmetrically positioned in the main body 38 where wrist and hand contact is most likely to occur. The magnetic portions 31 can be other than L-shaped and comprise only one piece, two, or more than two pieces according to desired area of effect. A plurality of extending portions 315 extend from a surface of each magnetic portions 31 in alignment with and is embedded in corresponding protrusions of the support 30.

When the user uses the keyboard 10, the support 30 massages and promotes blood circulation in the hands and wrists of the user. Thus, not only can the prevention and remedy of fatigue related symptoms be accomplished, but improved health as well.

It is to be understood, however, that even though numerous characteristics and advantages of certain embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A keyboard, comprising:
a support comprising at least one magnetic portion and a plurality of protrusions.

2. The keyboard of claim 1, wherein a number of the magnetic portions is two, the magnetic portions being positioned in two lateral portions of the support.

3. The keyboard of claim 2, wherein the magnetic portions are generally L-shaped and spaced from each other.

4. The keyboard of claim 1, wherein a plurality of extending portions extends from a surface of the magnetic portion in alignment with corresponding protrusions of the support.

5. The keyboard of claim 4, wherein the extending portions of the magnetic portion is embedded in corresponding protrusions of the support.

6. The keyboard of claim 1, wherein the support is made of soft, waterproof material.

7. A support for a keyboard, the support comprising:
a main body, the main body having a plurality of protrusions extending on a top surface thereof; and
at least one magnetic portion in the main body, the magnetic portion having a plurality of extending portions in alignment with the protrusions of the support.

8. The support of claim 7, wherein the extending portions of the magnetic portion is embedded in corresponding protrusions of the support.

9. The support of claim 7, wherein a number of the magnetic portions is two, the magnetic portions being positioned in two lateral portions of the support.

10. The support of claim 9, wherein the magnetic portions are generally L-shaped and spaced from each other.

11. The support of claim 7, wherein the main body of the support is made of soft, waterproof material.
